(19) United States
(12) Patent Application Publication
(10) Pub. No.: US 2007/0099561 A1
(43) Pub. Date: May 3, 2007

(54) System and method for tracking UMTS cell traffic

(76) Inventor: Juergen Voss, Wiesbaden (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/264,934

(22) Filed: Nov. 2, 2005

(51) Int. Cl. H04B 17/00

(52) U.S. Cl. 455/12.1; 455/67.11

(57) ABSTRACT

A system and method for providing cell-based statistics for messages related to the same call. The system and method can receive messages into a message coverage area, link the messages with a call with which they are associated, determine a radio link associated with the messages, create a data record if the radio link has been added, and providing the cell-based statistics that are associated with the messages and the message coverage area to the data record.

### BACKGROUND OF THE INVENTION

This invention relates generally to tracking the status of a mobile network, and more specifically to a system and method for tracking the status of a Universal Mobile Telecommunications System (UMTS) cell.

UMTS is a third generation (3G) access network related to mobile communications that provides a common interface to both Global System for Mobile communications (GSM) and General Packet Radio Service (GPRS) core network. 3G systems are intended to provide global mobility through services such as, for example, telephony, paging, messaging, Internet and broadband data. The International Telecommunication Union (ITU) started the process of defining the standard for 3G systems (IMT-2000) which was completed by the European Telecommunications Standards Institute (ETSI) in the form of UMTS. In 1998 Third Generation Partnership Project (3GPP) was formed to continue the technical specification work. 3GPP has five main UMTS standardization areas: Radio Access Network, Core Network, Terminals, Services and System Aspects and GSM Enhanced Data rates for GSM Evolution (EDGE) Radio Access Network (GERAN). In 1999 UMTS Phase 1 (Release '99, version 3) was complete.

A UMTS network consists of three interacting domains: Core Network (CN), UMTS Terrestrial Radio Access Network (UTRAN) and User Equipment (UE). The main function of the CN is to provide switching, routing and transit for user traffic. CN also contains the databases and network management functions. The basic CN architecture for UMTS is based on a GSM network with GPRS. All equipment has to be modified for UMTS operation and services. The UTRAN provides the air interface access method for UE. Base Station is referred to as Node-B, and control equipment for Node B is referred to as Radio Network Controller (RNC). The system areas from largest to smallest are as follows: UMTS, systems (including satellite), Public Land Mobile Network (PLMN), MSC/VLR or SGSN, Location Area, Routing Area (Packet Switch (PS) domain), UTRAN Registration Area (PS domain), Node B, and Sub cell.

The functions of Node-B are: Air interface Transmission/Reception, Modulation/Demodulation, Wideband Code Division Multiple Access (WCDMA) Physical Channel coding, Micro Diversity, Error Handing, Closed loop power control. The functions of RNC are: Radio Resource Control, Admission Control, Channel Allocation, Power Control Settings, Handover Control, Macro Diversity, Ciphering, Segmentation/Reassembly, Broadcast Signaling, Open Loop Power Control. Each RNC is connected to the CN (both packet and circuit domains) by the Iu interface; RNCs are connected together with the Iur interface. Each Node B is connected to an RNC by the Iub interface. One mobile station can have a radio connections to multiple cells/NodeB, and the RNC can switch between different data rates depends on the service usages.

The CN is divided into circuit switched (CS) and PS domains. Some of the CS elements are Mobile services Switching Centre (MSC), Visitor location register (VLR) and Gateway MSC. PS elements are Serving GPRS Support Node (SGSN) and Gateway GPRS Support Node (GGSN). Some network elements are shared by both domains.

The basic geographic unit of a cellular system such as UMTS is a cell. A city or county is divided into “cells,” each of which is equipped with a radio transmitter/receiver. The cells can vary in size depending upon terrain, capacity demands, etc. By controlling the transmission power, the radio frequencies assigned to one cell can be limited to the boundaries of that cell. When a wireless phone moves from one cell toward another, a computer at the Mobile Telephone Switching Office (MTSO) monitors the movement and at the proper time, transfers or hands off the phone call to the new cell and another radio frequency is assigned. The handoff or handover is performed so quickly that it is not noticeable to the callers.

There are three types of handovers: hard handover, soft handover, and softer handover. During hard handover, all the old radio links in the UE are removed before new radio links are established. Hard handover can be seamless or non-seamless. Seamless hard handover means that the handover is not perceptible to the user. In practice a handover that requires a change of the carrier frequency (inter-frequency handover) is always performed as hard handover.

During soft handover, radio links are added and removed in a way that the UE always keeps at least one radio link to the UTRAN. Soft handover is performed by means of macro diversity, which refers to the condition that several radio links are active at the same time. Normally soft handover can be used when cells operated on the same frequency are changed. Softer handover is a special case of soft handover where the radio links that are added and removed belong to the same Node B which is the site of co-located base stations from which several sector-cells are served.

A cell site is the location where the wireless antenna and network communications equipment is placed. The cell site consists of a transmitter/receiver, antenna tower, transmission radios and radio controllers. A cell site is operated by a Wireless Service Provider (WSP). More coverage and capacity can be created in a wireless system by having more than one cell site cover a particular amount of geography. In this case, each cell site covers a smaller area, with lower power MHz and thus offers the ability to reuse frequencies more times in a larger geographic coverage area, such as a city or metropolitan area.

A UE typically searches for a cell and determines a downlink scrambling code and frame synchronization of the cell. This process typically involves three steps: slot synchronization, frame synchronization and code-group identification, and scrambling-code identification. Slot synchronization typically requires that the UE use the Synchronization Channel's (SCH's) primary synchronization code to acquire slot synchronization to a cell. This is typically done with a single matched filter (or any similar device) matched to the primary synchronization code that is common to all cells. The slot timing of the cell can be obtained by detecting peaks in the matched filter output. Frame synchronization and code-group identification typically involve the UE which uses the SCH's secondary synchronization code to find frame synchronization and identify the code group of the cell found in the first step. This is done by correlating the received signal with all possible secondary synchronization code sequences, and identifying the maximum correlation value. Since the cyclic shifts of the sequences are unique, the code group as well as the frame synchronization is determined.

An SCH is a downlink signal used for cell search. The SCH consists of two sub channels, the primary and secondary SCH. The 10 ms radio frames of the primary and secondary SCH are divided into 15 slots, each of length 2560 chips. The primary SCH consists of a modulated code of length 256 chips, the primary synchronization code (PSC) is transmitted once every slot. The PSC is the same for every cell in the system. The secondary SCH consists of repeatedly transmitting a length 15 sequence of modulated codes of length 256 chips, the Secondary Synchronization Codes (SSC), transmitted in parallel with the primary SCH. Each SSC is chosen from a set of 16 different codes of length 256. This sequence on the secondary SCH indicates which of the code groups the cell's downlink scrambling code belongs to.

During the third and last step of the cell search procedure, the UE determines the exact primary scrambling code used by the found cell. The primary scrambling code is typically identified through symbol-by-symbol correlation over the CPICH with all codes within the code group identified in the second step. After the primary scrambling code has been identified, the Primary CCPCH can be detected and the system- and cell-specific BCH information can be read. Scrambling codes can be reused.

Prior art call trace applications for aiding troubleshooting group together all signaling messages that relate to a single call or data session. A message is a quantum of electronic information. A large number of calls/sessions can be displayed in this way and errors can be identified as they are highlighted graphically. Call identification variables and statistics can be shown, as well as variables such as International Mobile Subscriber Identity (IMSI), setup time, and clear down time. A call trace application can also allow display of message sequences that can simplify multi-segment message flow diagrams and control messaging across multiple network elements. A call trace application can provide UMTS call traces across the Iub, Iur and Iu interfaces. An Iub session trace tool for a UMTS Iub interface can capture and group signaling messages for Node B Application Part (NBAP), Access Link Control Application Protocol (ALCAP), Radio Resource Control (RRC) and other protocols. An Iu session trace tool for a UMTS Iu interface can capture and group the signaling messages for user sessions such as Packet Data Protocol (PDP) context and UMTS Attach/Detach procedures. An Iur session trace tool for a UMTS Iur interface can capture and group the signaling messages for Radio Network Subsystem Application Part (RNSAP), ALCAP and RRC and other protocols.

A call trace application can be augmented to define important call specific parameters such as, for example, call identification, call disposition, call duration, mobile identification, dialed/calling number, call type (short message service (SMS)/PDP/setup/location update, etc.) that can be calculated for Iub and Iur interfaces. Further, a call trace application can gather various statistics for studying the performance and trend in an Asynchronous Transfer Method (ATM) network based on parameters such as, for example, use type, statistic type (such as, for example, frame count, byte count, and frames/sec) and patterns (such as, for example, range list and wild card).

The general flow of a call trace application is as follows: (1) messages are monitored on an interface; (2) received messages are decoded and deciphered; (3) decoded and deciphered messages that relate to the same call are linked together; and (4) Key Performance Indicators (KPIs) and information elements are extracted from the messages and written to the Call Data Record (CDR). In other words, calls are reassembled over time, and analysis software creates graphic representations of the statistics associated with calls that indicate the different states of each call, and therefore highlights errors.

With respect to UMTS cells, prior art cell-based statistics are collected, for example, by monitoring messages on an interface, decoding and deciphering those messages, counting those messages, and linking them to a particular cell.

What is needed is a tool that (a) processes and presents data that are associated with a cell, and (b) post-processes the Iub signal and user data. The call-based UTRAN system uses CDRs. The current available data per call indicate an initial cell, a final cell, a failure cell, and a Block Error Rate (BLER) as an average over call setup. The call-based view does not provide the following information that is needed for cell-based network analysis: (a) cells that are used during call establishment, (b) cell-based KPI such as, for example, BLER, Quality Estimation, and RLC Retransmission, (c) RRC Connection Setup Rate, (d) duration of established soft handover leg, (e) used radio resource/established radio resource such as, for example, whether or not a WAP service uses a 384 kb pipe established on the radio interface or how long it takes to reconfigure a link, (f) how many calls had been established in parallel in a cell (an indication of a bad radio link), and (g) soft handover legs that are not needed. In the situation where there are many cells, efficient low level troubleshooting and a high level of problem indication are needed. Likewise, it is useful to examine fine-grained data in order to isolate the failed or failing cells.

Cell-based processing could summarize data for a single cell or Node B (referred to as either cell, Node B, or cell/Node B hereafter) over time because multiple users can share the network resources of WCDMA technologies and thus different calls could influence each other. With the ubiquitous use of UMTS, there is a need for identifying the problems associated with such influence by tracking cell-based activity while maintaining the call relationship between messages.

Such cell-based processing could help to quickly highlight problems in a cell/Node B through analysis of statistics associated with common NBAP messages. Also, representation of the statistics, for example in three-dimensional diagrams, based on cell-based messages could help to optimize cell/Node B radio and Iub/Iur resources and assist in network planning. Cell-based statistical analysis could reduce the time it takes to analyze large data log files, could provide a detailed overview of what is happening in the network, and could highlight problems that cannot be analyzed or indicated with prior art signaling analyzers.

### SUMMARY OF THE INVENTION

The needs set forth above as well as further and other needs and advantages are addressed by the present invention. The solutions and advantages of the present invention are achieved by the illustrative embodiment described herein below.

The system and method of the present invention can provide cell-based statistics and analyses for messages related to the same call. The method of the present invention can include, but is not limited to, the steps of receiving messages into a message coverage area, such as, for example, a cell, through an interface and linking the messages to each other according to the call with which they are associated. The method can also include the steps of determining radio links associated with the messages, creating a data record such as, for example, a CDR if the radio links had not been previously registered in the system, and providing the cell-based statistics to the data record, where the cell-based statistic is associated with the messages and the message coverage area. The method of the present invention can optionally include the steps of providing quality information to the data record, providing neighboring message coverage area information to the data record, providing measurement results of the at least one statistic to the data record, and incrementing a message count associated with the message coverage area when the messages are processed.

The method of the present invention can still further optionally include the steps of monitoring the interface to detect the messages, decoding the messages to determine the call with which the messages are associated, and deciphering the messages to determine the cell-based statistics.

The system of the present invention can include, but is not limited to, a cell message receiver that can receive messages into a message coverage area such as, for example, a cell, through an interface and a message call linker that can link the received messages to other messages in the message coverage area if the received messages are part of the same call as the other messages. The system can also include a radio link finder that can determine which radio link is associated with the received messages and a data record creator that can create a data record associated with the radio link. The system can also include a data record populator that can populate the data record with cell-based statistics associated with the received messages and the message coverage area. Optionally, the data record populator can gather quality information, neighboring message coverage area information, and measurement results, and store them in the data record.

For a better understanding of the present invention, together with other and further objects thereof, reference is made to the accompanying drawings and detailed description. The scope of the present invention is pointed out in the appended claims.

### DESCRIPTION OF THE SEVERAL VIEWS OF THE DRAWING

FIG. 1A is a diagrammatic plan of the geographic environment in which the system of the present invention could execute;

FIGS. 1B and 1C are diagrams of overlapping multi-celled configurations;

FIG. 2A is a schematic block diagram of the network environment in which the system of the present invention can execute;

FIG. 2B is an expanded schematic block diagram of components of interest in the network environment of the present invention;

FIG. 3 is a schematic block diagram of the system of the present invention;

FIG. 4 is a flowchart of the method of the present invention;

FIGS. 5A and 5B are schematic diagrams illustrating exemplary call-based and cell-based CDR creation configurations, respectively.

FIG. 6A is a schematic diagram illustrating an exemplary configuration under which cell-based statistics could be useful.

FIG. 6B is a schematic diagram illustrating exemplary handover configurations.

FIG. 6C is a schematic diagram illustrating heavily loaded and lightly loaded cell configurations.

FIG. 7 is an illustrative radio link setup diagram produced by the system and method of the present invention;

FIG. 8 is an illustrative bit rate diagram produced by the system and method of the present invention;

FIG. 9 is an illustrative cell-based Signal-to-Interference Ratio (SIR), Quality Estimate (QE), and Cyclic Redundancy Checksum Indicator (CRCI) diagram produced by the system and method of the present invention; and

FIG. 10 is an illustrative dedicated measurement analysis diagram produced by the system and method of the present invention.

### DETAILED DESCRIPTION OF THE INVENTION

The present invention is now described more fully hereinafter with reference to the accompanying drawings, in which the illustrative embodiment of the present invention is shown. The following configuration description is presented for illustrative purposes only. Any computer configuration satisfying the speed and interface requirements herein described may be suitable for implementing the system of the present invention.

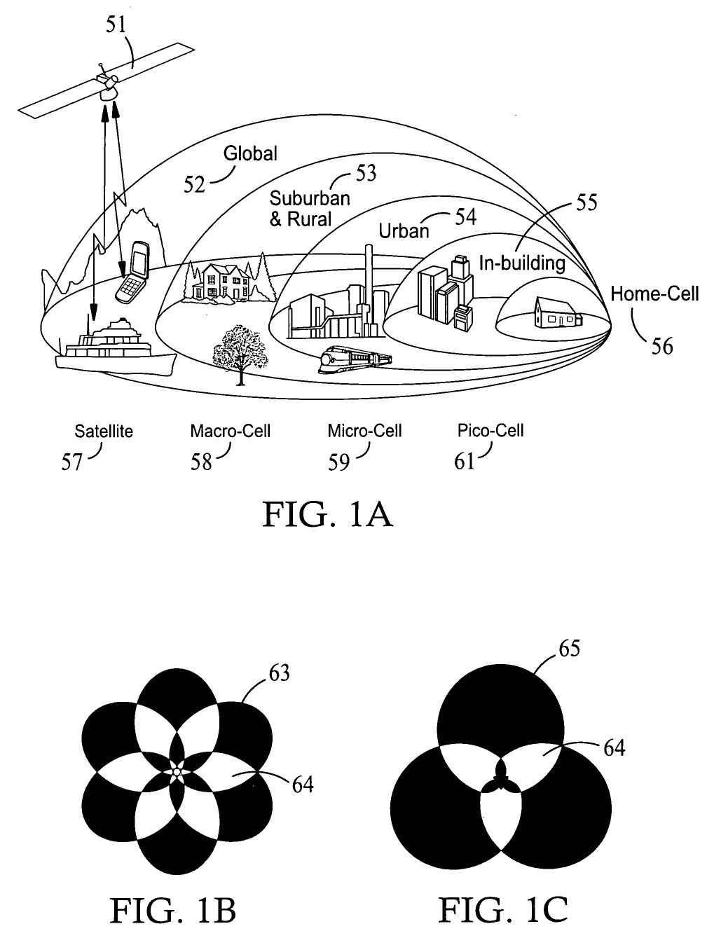

Referring now to FIG. 1A, a geographic environment in which the present invention could operate is shown. In particular, UMTS cell configuration can be viewed in relation to coverage areas. At one end of the spectrum, a home configuration can confine transmissions to a home, while at the other end of the spectrum, a global configuration 52 can provide for cellular service around the world through use of at least one antenna 51. In-building 55, urban 54, and suburban/rural 53 configurations can provide intermediate coverage area sizes. Each of these geographic distinctions can be grouped according to size as shown. For example, home-cell 52 can accommodate an in-home configuration, pico-cell 61 can accommodate in-building configuration 55, while micro-cell 59 can accommodate urban configuration 54. Moving up the size scale, macro-cell 58 can accommodate suburban/rural configuration 53, and finally satellite 57 can accommodate global configuration 52.

Referring now to FIGS. 1B and 1C, cells can be deployed in various overlapping configurations such as, for example, six-celled configuration 63 (FIG. 1B), and three-celled configuration 65 (FIG. 1C). The use of six-celled configuration 63 can lead to an increase in the coverage area that is served by multiple cells, also known as the soft handover region, depending on the local propagation conditions and the antenna pattern. FIGS. 1B and 1C show overlap 53 between the antenna patterns. In a practical deployment the amount of overlap 64 could be greater due to the effect of adjacent sites. Overlap 64 could be the cause of interference, the impact of which can be minimized by a soft handover mechanism.

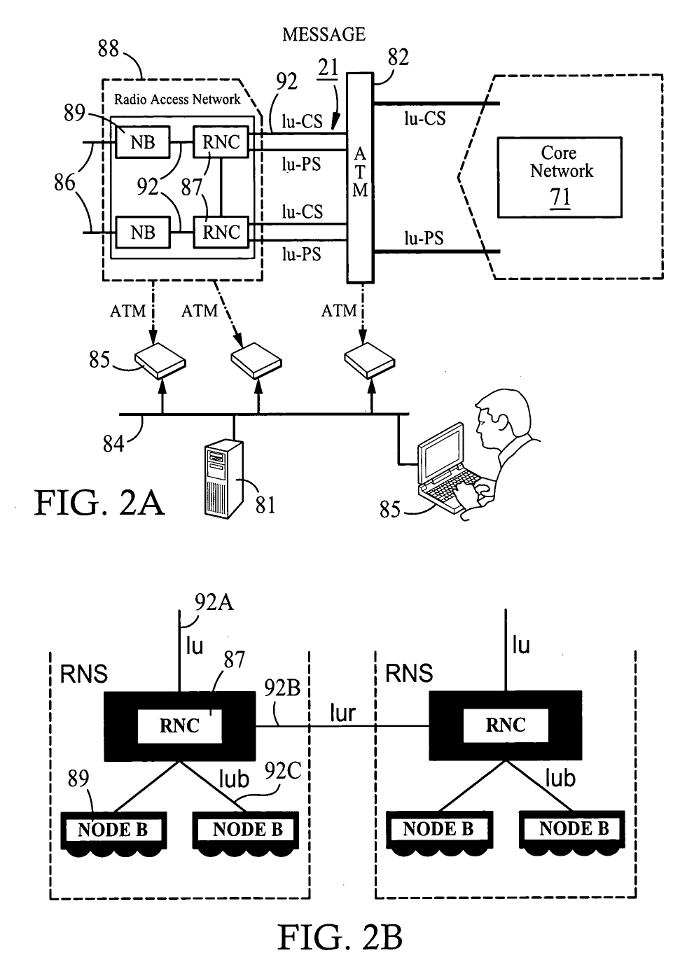

Referring now to FIG. 2A, the network environment in which the present invention could execute is shown. Radio Access Network (RAN) 88 can include at least one cell/Node B 89 and at least one RNC 87, each of which can receive messages 21 from interfaces 92. Interfaces 92 can receive messages 21 from an ATM network 82 that receives messages from a core network 71. Computers 85 can monitor messages at interfaces 92, transmit statistics 27 gathered from messages 21 over communications network electronic interface 84, and store statistics 27 gathered from messages 21 on computer-readable medium 81.

Referring to FIG. 2B, an expanded view of RNC 87 and cell/Node B 89 as interconnected and connected to outside devices by Iu 92A, Iur 92B, and Iub 92C interfaces is shown. A call trace data feed can include software handover and individual leg information. A cell trace data feed could begin with individual leg information and vary that to produce a cell-based parameters and cell-based KPI.

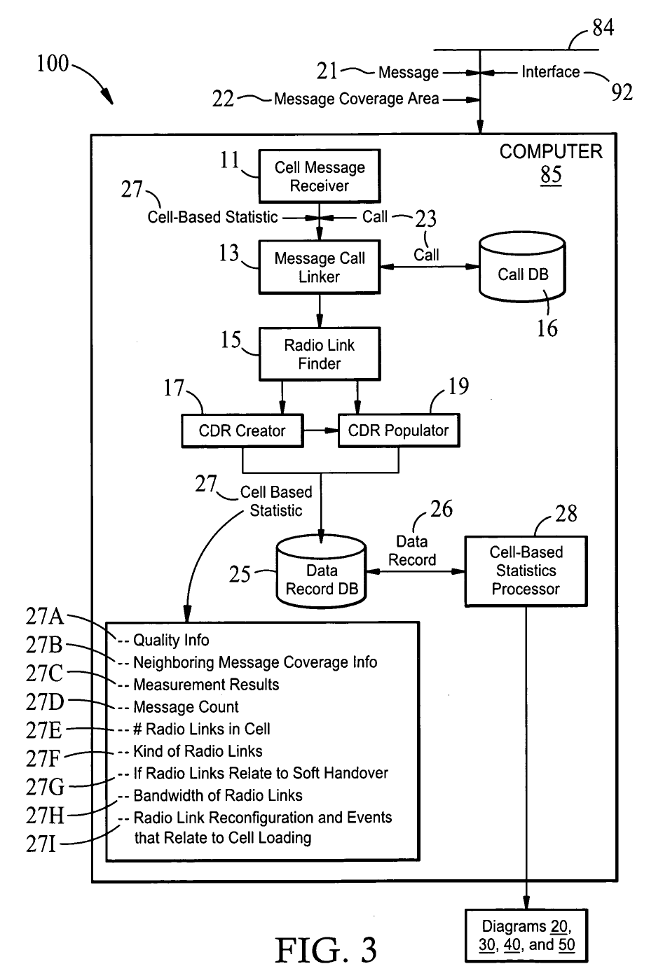

Referring now to FIG. 3, system 100 of the present invention can include, but is not limited to, cell message receiver 11 capable of receiving messages 21 into message coverage area 22 through interface 92, message call linker 13 capable of linking the received messages 21 to other messages 21 in message coverage area 22 if the received messages 21 are part of the call 23 that is associated with other messages 21. System 100 can also include radio link finder 15 capable of determining radio link 86 that is associated with received messages 21, data record creator 17 capable of creating data record 26 that is associated with radio link 86, and data record populator 19 capable of providing cell-based statistics (27) that are associated with received messages 21 and message coverage area 22 in data record 26. Data record populator (19) can provide, but is not limited to providing, quality information 27A, neighboring message coverage area information 27B, and measurement results 27C to data record 26. Further, cell message receiver 11 is capable of incrementing message count 27D associated with message coverage area 22 when received messages 21 are processed. System 100 can optionally include cell-based statistics processor 28 capable of accessing data record 26 and providing cell-based statistics 27 in the form of a diagram.

Referring still further to FIG. 3, system 100 can execute in computer 85, and can receive, through network electronic interface 84, messages 21, interface 92 associated with messages 21, and message coverage area 22, such as, for example, cell/Node B 89. System 100 can optionally include call database 16 and data record database 25. Call database 16 can maintain records of which messages 21 are associated with which calls 23, and data record database 25 can maintain call data record and cell-based call information associated with messages 21. Cell-based statistics 27 can include, but are not limited to, quality info 27A, neighboring message coverage info 27B, measurement results 27C, message count 27D, number radio links in cell 27E, kind of radio links 27F, if radio links relate to soft handover 27G, bandwidth of radio links 27H, and radio link reconfiguration and events that relate to cell loading 27I.

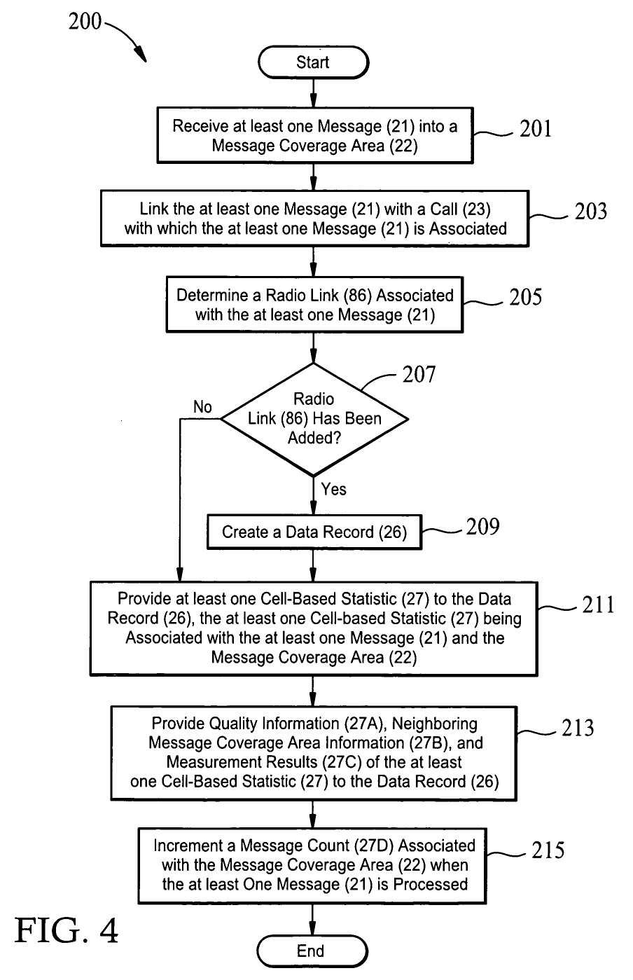

Referring now primarily to FIG. 4, method 200 can include, but is not limited to, the steps of receiving messages 21 (FIG. 3) into message coverage area 22 (FIG. 3) (method step 201), linking messages 21 with calls 23 (FIG. 3) that are associated with messages 21 (method step 203), and determining radio link 86 (FIG. 2A) that is associated with messages 21 (method step 205). If radio link 86 has been added (decision step 207), method 200 can include the step of creating data record 26 (FIG. 3). If radio link 86 has not been added (decision step 207), method 200 can include the steps of providing cell-based statistics 27 (FIG. 3) that are associated with messages 21 and message coverage area 22 to data record 26. Optionally, method 200 can include the steps of providing quality information 27A (FIG. 3) to data record 26, providing neighboring message coverage area information 27B (FIG. 3) to data record 26, providing measurement results 27C (FIG. 3) of cell-based statistics 27 to data record 26, and incrementing message count 27D (FIG. 3) associated with message coverage area 22 when messages 21 are processed.

With further reference to FIG. 4, method 200 can be, in whole or in part, implemented electronically. Signals representing actions taken by elements of system 100 (FIG. 3) can travel over electronic communications media 84 (FIG. 2A). Control and data information can be electronically executed and stored on computer-readable media 81 (FIG. 2A). Method 200 can be implemented to execute on at least one node 85 (FIG. 2A) in at least one communications network 71 (FIG. 2A). Common forms of computer-readable media 81 include, for example, a floppy disk, a flexible disk, a hard disk, magnetic tape, or any other magnetic medium, a CDROM or any other optical medium, punched cards, paper tape, or any other physical medium with patterns of holes, a RAM, a PROM, and EPROM, a FLASH-EPROM, or any other memory chip or cartridge, a carrier wave, or any other medium from which a computer can read.

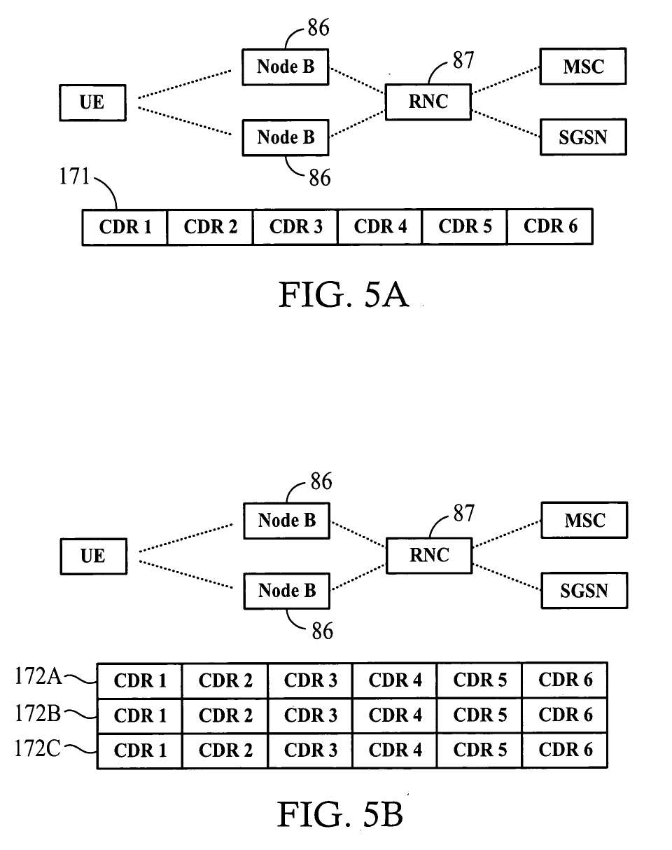

Referring now to FIG. 5A, one possible configuration for creating a call-based CDR is shown. Call-based CDR can be shown in one CDR line 171 from the beginning of the call to the end of the call. If a call is dropped in one stage of the call procedure, that can be indicated in one CDR. Individual CDRs in CDR line 171 can also indicate protocol influences on the CN and RAN. However, how long and how often a call is in softer/softer handover, or the neighbor cell measurements, are not indicated.

Referring now to FIG. 5B, cell-based CDR creation can require analysis of the phases of calls in cell CDR line one 172A, cell CDR line two 172B, and cell CDR line three 172C to indicate the KPI for a particular time frame. Thus, CDR lines for new and existing legs can be created if, for example, (a) a new soft handover leg is established, (b) a new softer handover leg is established, (c) a radio link is reconfigured, or (d) when there is physical channel reconfiguration/cell update. With these new data, post processing can indicate, for example, (a) KPI per Leg (e.g. BLER, RLC Retransmission), (b) KPI per data rate (e.g. BLER, RLC Retransmission), (c) cell loading time, (d) what an additional leg could contribute to the overall connection, (e) time arrival information, and/or (f) new neighbor cell description and measurement report.

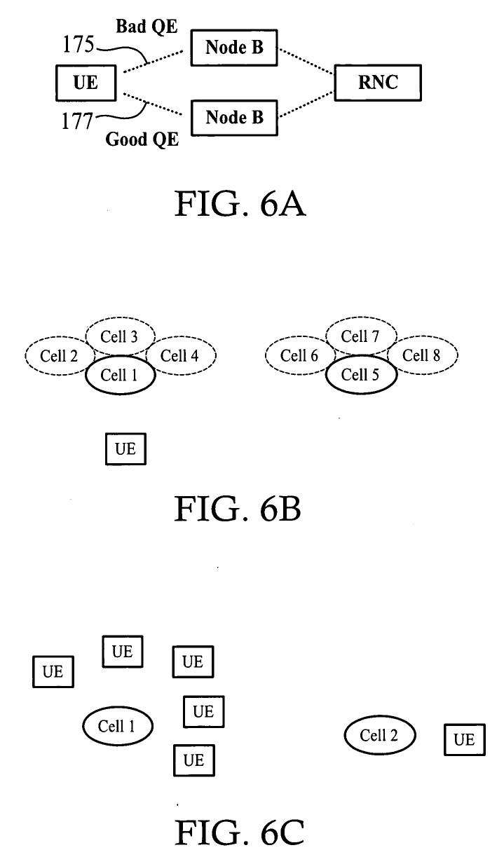

Referring now to FIG. 6A, soft handover legs 175 and 177 can contribute differently to the overall connection. Thus certain statistics can assist in the optimization task such as, for example, (a) which cell/NodeB has a soft handover with pure quality, a statistic gathered for the purpose of removing the soft handover from the neighboring cell description, (b) the measured CPICH, a statistic gathered so that if the leg has a poor coverage, a new leg could be added, and (c) the overall cell load during the time frame in which a bad QE is indicated.

Referring now to FIG. 6B, another statistic that could be gathered is the reported neighbor cell list. This statistic could indicate (a) if, when the UE is in Cell_Dedicated Channel(DCH) mode, cells 2-4 could be possible candidates for a soft/softer handover from cell 1, (b) if, when the UE is in the Cell_Forward Access Channel(FACH) mode, no soft/softer handover is possible, (c) if, when the UE is in soft/softer handover with cell 1 and cell 5, cells 2-8 could be candidates for soft handover. These statistics could indicate call drop or quality variation.

Referring now to FIG. 6C, high loaded cell 1 and a low loaded cell 2 are shown. Unlike GSM, UMTS does not have timeslots. Instead, a user can allocate a noise level. Statistics can be gathered to assess how the noise level could influence a single call. With those statistics, a user or operator may conclude that no soft handover can be made during, for example, a 384 kb rate call in busy cell 1.

Following is a candidate list of statistics that can be gathered with respect to cell-based tracing. This list is not exclusive, merely exemplary.

GENERAL IUB INFORMATION

Call Id
VPI - Needed for not grouped messages
Bearer - Needed for not grouped messages
Duration
Status
Start Time
Establishment Cause
International Mobile Subscriber Identity (IMSI)
International Mobile Equipment Identity (IMEI)
Oldest Temporary Mobile Subscriber Identity (TMSI) CS
Latest TMSI CS
Oldest TMSI PS
Latest TMSI PS
Link Access Control (LAC)
Routing Area Code (RAC)
SAC
Cell Identifier
NBAP Cause
ALCAP Cause
RRC Release Cause
RRC Reject Cause
Radio Access Network Application Part (RANAP) Cause
Service Type
Cell Update Cause
RRC State Indicator
Scrambling Code
Uplink (Reverse Link) (UL)_Scrambling Code
Iu User Plane (UP)_Max_Bit_Rate_CS
Iu UP_Max_Bit_Rate_PS
Iu_{—} Downlink (Forward Link) (DL)_Max_Bit_Rate_CS
Iu_DL_Max_Bit_Rate_PS
NBAP UL Max Number Transport Block (TB) Signaling
NBAP DL Max Number TB Signaling
NBAP Time Transmission Interval Signaling
NBAP UL Max Number TB Data
NBAP DL Max Number TB Data
NBAP Time Transmission Interval
NBAP TB Speech
NBAP DL Slot Format
NBAP Initial DL Power
NBAP Minimum DL Power
NBAP Maximum DL Power
ALCAP Max Forward CPS-SDU Bit Rate
ALCAP Max Backwards CPS-SDU Bit Rate
ALCAP Avg Forward CPS-SDU Bit Rate
ALCAP Avg Backward CPS-SDU Bit Rate
MESSAGES COUNTER
No of RRC Connection Request
No of RRC Connection Setup
No of RRC Connection Setup Complete
No of RRC Connection Reject
No of Radio Link Setup
No of Radio Link Setup Complete
No of Radio Link Failure
No of Radio Link Reconfiguration Prepare
No of Radio Link Reconfiguration Ready
No of Radio Link Reconfiguration Commit
No of Radio Link Reconfiguration Failure
No of Radio Link Addition Request
No of Radio Link Addition Response
No of Radio Link Addition Failure
No of Active Setup Update Request
No of Active Setup Update Response
No of Active Setup Update Failure
No of ALCAP EST [please define] Request
No of ALCAP EST Confirm
No of ALCAP EST Reject
No of ALCAP Release Request
No of ALCAP Release Confirm
TIMER
RRC Connection Setup Time
Radio Link Setup Time
Radio Link Reconfiguration Setup Time
ALCAP Setup Time
Average Time between Radio Link Reconfiguration
QUALITY
UL Quality Estimation Signaling
UL Block Error Rate Signaling
UL Quality Estimation User Plane
UL Block Error Rate User Plane
SIR Target Max
SIR Target Min
NBAP Dedicated Measurement Report - SIR ERROR Value
NEIGHBOUR CELL MEASUREMENT
INTRA FREQUENCY
Measurement Reports:
Intra Frequency Measurement
Inter Frequency Measurement
Inter RAT Measurement
UE-Positioning Measurement
Traffic Volume Measurement
Quality Measurement
Measurement Control - Intra Frequency Count
Measurement Control - Intra Frequency Service Code (SC) 1
Measurement Control - Intra Frequency CPICH Transmit (TX) Power 1
Measurement Control - Intra Frequency SC 2
Measurement Control - Intra Frequency CPICH TX Power 2
Measurement Control - Intra Frequency SC 3
Measurement Control - Intra Frequency CPICH TX Power3
Measurement Control - Intra Frequency SC 4
Measurement Control - Intra Frequency CPICH TX Power 4
Measurement Control - Intra Frequency SC 5
Measurement Control - Intra Frequency CPICH TX Power 5
Measurement Control - Intra Frequency SC 6
Measurement Control - Intra Frequency CPICH TX Power 6
Measurement Control - Intra Frequency SC 7
Measurement Control - Intra Frequency CPICH TX Power 7
Measurement Control - Intra Frequency SC 8
Measurement Control - Intra Frequency CPICH TX Power 8 - May trigger event
missing
Measurement Report - Intra Frequency Count
Measurement Report - Intra Frequency SC 1
Measurement Report - Intra Frequency CPICH Ec/Io 1
Measurement Report - Intra Frequency SC 2
Measurement Report - Intra Frequency CPICH Ec/Io 1
Measurement Report - Intra Frequency SC 3
Measurement Report - Intra Frequency CPICH Ec/Io 1
Measurement Report - Intra Frequency SC 4
Measurement Report - Intra Frequency CPICH Ec/Io 1
Measurement Report - Intra Frequency SC 5
Measurement Report - Intra Frequency CPICH Ec/Io 1
Measurement Report - Intra Frequency SC 6
Measurement Report - Intra Frequency CPICH Ec/Io 1
Measurement Report - Intra Frequency SC 7
Measurement Report - Intra Frequency CPICH Ec/Io 1
Measurement Report - Intra Frequency SC 8
Event Result Type —Intra Frequency
Event Result - 3 SC - Open the maximum number of measurement reports needs to define
NEIGHBOUR CELL MEASUREMENT
INTER RAT MEASUREMENT
Measurement Control Inter RAT -NewInterRATCellList Count
Measurement Control Inter RAT Network Colour Code (NCC)_1
Measurement Control Inter RAT Base Transceiver Station (BTS) Colour (BCC)_1
Measurement Control Inter RAT Frequency_Band_1
Measurement Control Inter RAT Broadcast Control Channel (BCCH)_{—} Absolute Radio
Frequency Channel Number (ARFCN)_1
Measurement Control Inter RAT NCC_2
Measurement Control Inter RAT BCC_2
Measurement Control Inter RAT Frequency_Band_2
Measurement Control Inter RAT BCCH_ARFCN_2
Measurement Control Inter RAT NCC_3
Measurement Control Inter RAT BCC_3
Measurement Control Inter RAT Frequency_Band_3
Measurement Control Inter RAT BCCH_ARFCN_3
Measurement Control Inter RAT NCC_4
Measurement Control Inter RAT BCC_4
Measurement Control Inter RAT Frequency_Band_4
Measurement Control Inter RAT Measurement Control Inter RAT BCCH_ARFCN_4
Measurement Control Inter RAT NCC_5
Measurement Control Inter RAT BCC_5
Measurement Control Inter RAT Frequency_Band_5
Measurement Control Inter RAT BCCH_ARFCN_5
Measurement Control Inter RAT NCC_6
Measurement Control Inter RAT BCC_6
Measurement Control Inter RAT Frequency_Band_7
Measurement Control Inter RAT BCCH_ARFCN_7
Measurement Control Inter RAT NCC_8
Measurement Control Inter RAT BCC_8
Measurement Control Inter RAT Frequency_Band_8
Measurement Control Inter RAT BCCH_ARFCN_8
Measurement Control Inter RAT NCC_9
Measurement Control Inter RAT BCC_9
Measurement Control Inter RAT Frequency_Band_9
Measurement Control Inter RAT BCCH_ARFCN_9
Measurement Control Inter RAT NCC_10
Measurement Control Inter RAT BCC_10
Measurement Control Inter RAT Frequency_Band_10
Measurement Control Inter RAT BCCH_ARFCN_10
Measurement Control Inter RAT NCC_11
Measurement Control Inter RAT BCC_11
Measurement Control Inter RAT Frequency_Band_11
Measurement Control Inter RAT BCCH_ARFCN_11
Measurement Control Inter RAT NCC_12
Measurement Control Inter RAT BCC_12
Measurement Control Inter RAT Frequency_Band_12
Measurement Control Inter RAT BCCH_ARFCN_12
Measurement Control Inter RAT InterRATEvent Type
Measurement Control Inter RAT Threshold
Inter RAT Measured Results List Count
Inter RAT Measured Results List GSM_Carrier Received Signal Strength Indicator
(RSSI)_1
Inter RAT Measured Results List Verified Base transceiver Station Identity Code
(BSIC)_1
Inter RAT Measured Results List GSM_CarrierRSSI_2
Inter RAT Measured Results List VerifiedBSIC_2
Inter RAT Measured Results List GSM_CarrierRSSI_3
Inter RAT Measured Results List VerifiedBSIC_3
Inter RAT Measured Results List GSM_CarrierRSSI_4
Inter RAT Measured Results List VerifiedBSIC_4
Inter RAT Measured Results List GSM_CarrierRSSI_5
Inter RAT Measured Results List VerifiedBSIC_5
Inter RAT Measured Results List GSM_CarrierRSSI_6
Inter RAT Measured Results List VerifiedBSIC_6
Inter RAT Measured Results List GSM_CarrierRSSI_7
Inter RAT Measured Results List VerifiedBSIC_7
Inter RAT Measured Results List GSM_CarrierRSSI_8
Inter RAT Measured Results List VerifiedBSIC_8
Inter RAT Measured Results List GSM_CarrierRSSI_9
Inter RAT Measured Results List VerifiedBSIC_9
EventIDInterRAT
VerifiedBSIC
Handover From UTRAN Command GSM - BS Colour Code
Handover From UTRAN Command GSM - Public Land Mobile Network (PLMN)
Color Code
Handover From UTRAN Command GSM - 3 BCCH ARFCN
INTER FREQUENCY MEASUREMENT
Tbd. Same as Intra Frequency
TIME ADVANCED
Frame Protocol (FP) UL Time of Arrvial
CALCULATED MEASUREMENT
Time Between Reconfiguration
With which Cell the Call is in Soft Handover
Contribution in % to the Soft Handover
Time between Radio Link Addition
Time between Radio Link Setup and Deletion
COMMON MESSAGES - 3 CELL BASED
Common Measurement Report RSSI
Common Measurement Report TX Power
Cell Setup, Deletion, Reconfiguration

A first possible analysis output is a tabular statistic (not shown) that enables an operator to see problems in the network related to cell/Node B 89 (FIG. 2A). The values in the tabular statistic could be based, for example, on the Virtual Path Identifier (VPI) if, for example, each VPI were associated with one Node B and several cells. To facilitate this tabular statistic, the following values could be added to the CDR: used frequency (UARFC), used scrambling code (SC), defined T-cell value (T-Cell), status (indicating if the cell/Node B 89 currently has a problem based on the received NBAP messages). The status can be color-coded in the diagram. The tabular statistic could include, but is not limited to: export list; cell information such as, for example, Cell Identity (CI), Link Access Control (LAC), Service Area Code (SAC), RNC identification; name of cell/position; measured neighbor cell in single leg handover including, for example, intra cell list, inter cell list, and inter RAT list; measured neighbor cell in soft handover with cell x including, for example, intra cell list, inter cell list, and inter RAT list; percentage of cell load time based including, for example, soft handover, softer handover, CS calls, PS calls, and signaling only; and percentage of soft handover contribution of cell x.

Referring now primarily to FIG. 5, radio link setup/radio link reconfiguration over time diagram 20 is shown that could indicate the number of radio links 86 (FIG. 2A) set up in a cell/Node B 89 (FIG. 2A) over time 102, the type of radio link 86 (e.g. signaling, speech, data), whether radio link 86 relates to soft handover (macro diversity), and the bandwidth of radio link 86. Additionally a radio link reconfiguration 107 and other events, such as, for example, blocking, that relate to the loading of cell/node B 89 could be shown. Messages 21 (FIG. 2A) containing values that can be mapped to a spreading factor can be used to populate data record 26 (FIG. 3) and ultimately radio link setup diagram 20. As shown in radio link setup diagram 20, the height of an individual block can indicate the spreading factor, and the position of the block along the Y-axis can indicate an Orthogonal Variable Spreading Factor (OVSF) position. This information can be used to visually indicate which codes are in use and how effectively the RNC is using resources on radio interface 92 (FIG. 2A). In radio link setup diagram 20, the upper line can indicate useful common NBAP messages 21 or radio link failure messages in order to give a visual representation of cell performance (such as, for example, radio link failure due to the unavailability of radio resources). Radio link setup diagram 20 could also indicate radio links 86 that relate to soft/softer handover according to information gathered in the call trace of the prior art. In the case of macro diversity, radio link setup diagram 20 could indicate which part of the loading on cell/Node B 89 is related to soft handover. Macro diversity, which means that the UE has a connection to multiple cells/Nodes B 89 at the same time, could be indicated in the radio link setup diagram 20 by, for example, a different color. If at some point in time, call 23 has only one radio link 86 (also known as a leg), then macro diversity is not indicated and the color in the radio link setup diagram 20 could reflect the change.

Referring now to FIG. 6, illustrative bit rate diagram 30 can display information about calls 23 (FIG. 3) related to cell/Node B 89 (FIG. 2A). For example, maximum allocated bit rate 104 and average allocated bit rate 106 over time 102 as shown in an ALCAP establishment request message having values such as maximum and average forward and background Common Part Sublayer Service Data Unit (CPS_SDU) bit rate and path identifier could be displayed.

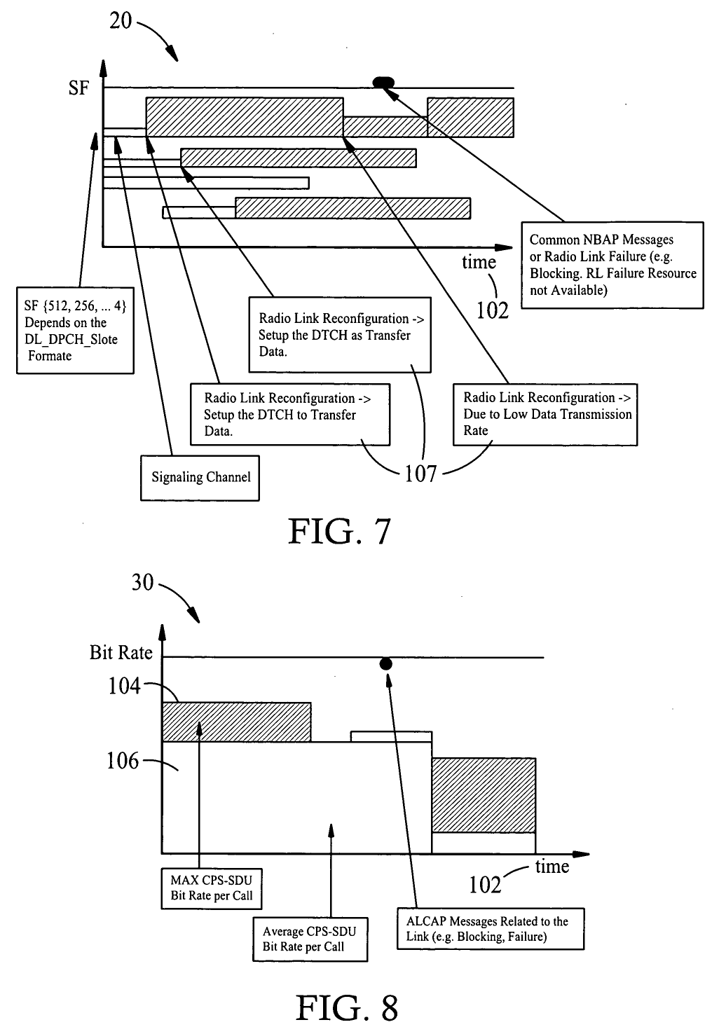

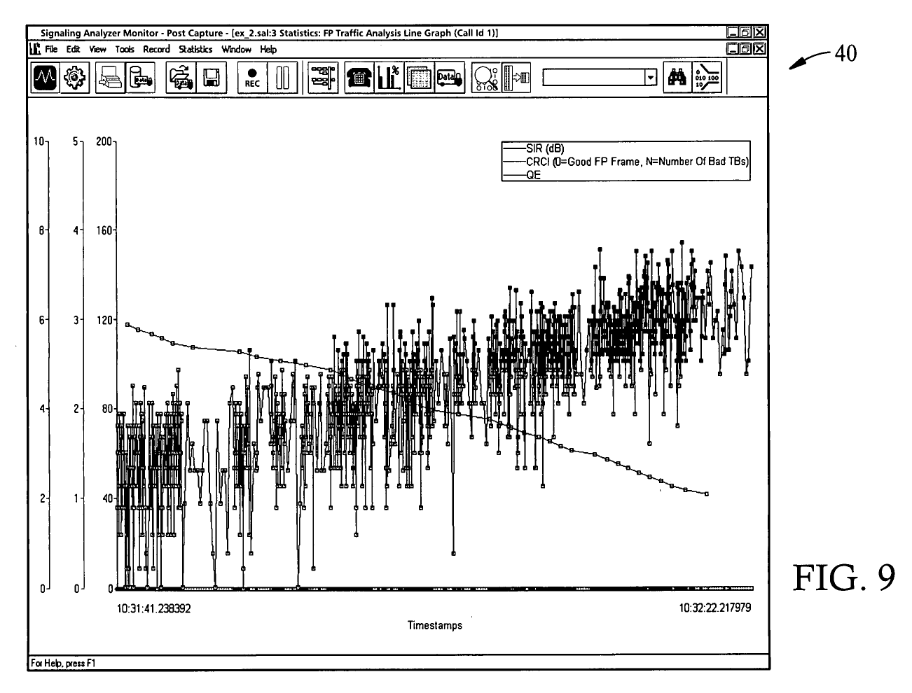

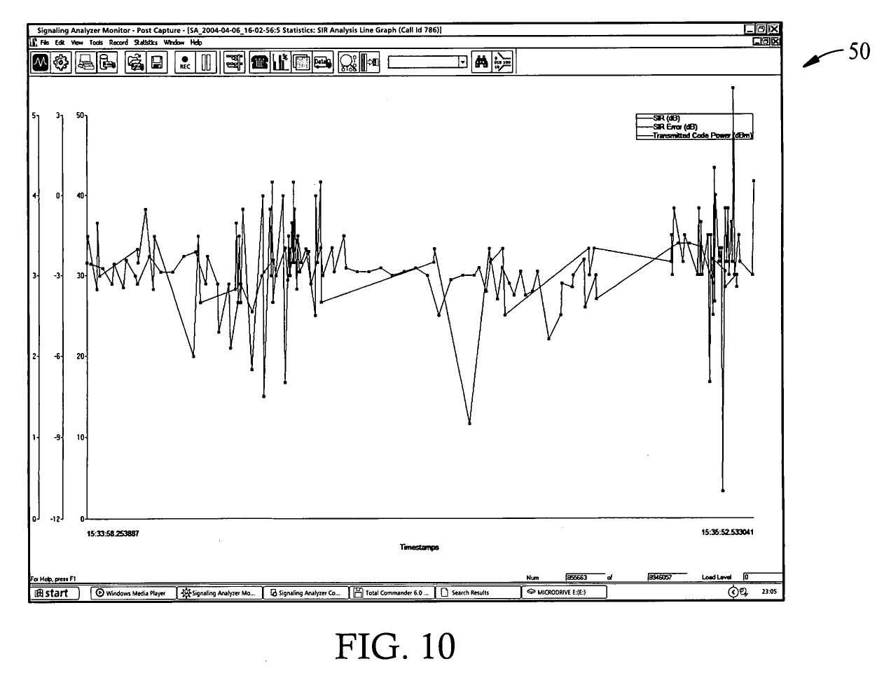

Referring now to FIG. 7, illustrative cell-based SIR, QE, and CRCI diagram 40 can display SIR, QE, and CRCI analyses per cell. Cell-based SIR, QE, and CRCI diagram 40 could assist in isolating problems that result from multiple calls 23 (FIG. 3) within the WCDMA technology. Cell-based SIR, QE, and CRCI diagram 40 could also indicate an average QE value.

Referring now to FIG. 8, illustrative dedicated measurement analysis diagram 50 can display dedicated measurement analysis per cell. Dedicated measurement analysis diagram 50 could assist in understanding problems between multiple calls 23 (FIG. 3) within the WCDMA technology.

Although the invention has been described with respect to various embodiments, it should be realized this invention is also capable of a wide variety of further and other embodiments.

What is claimed is:

1. A method for providing at least one cell-based statistic for at least one message related to a call, said method comprising the steps of:
receiving the at least one message into a message coverage area;
linking the at least one message with the call with which the at least one message is associated;
determining a radio link associated with the at least one message;
creating a data record related to the radio link if no data record has already been established for the radio link; and
providing the at least one cell-based statistic to the data record, the at least one cell-based statistic being associated with the at least one message and the message coverage area.

2. The method as in claim 1 further comprising the step of:
providing quality information to the data record;
providing message coverage area information to the data record;
providing measurement results of the at least one cell-based statistic to the data record; and
incrementing a message count associated with the message coverage area when the at least one message is processed.

3. The method as in claim 1 wherein said step of receiving comprises the steps of:
monitoring at least one interface associated with the message coverage area to detect the at least one message;
determining the call from the at least one message with which the at least one message is associated; and
determining the at least one cell-based statistic from the call.

4. A method for determining which calls in a cell influence each other and for determining usage of network resources over time, said method comprising the steps of:
receiving at least one message into a cell through at least one interface;
linking the at least one message with a call with which the at least one message is associated;
determining a radio link associated with the at least one message;
creating a data record related to the radio link if no data record has already been established for the radio link;
providing at least one cell-based statistic to the data record, the at least one cell-based statistic being associated with the at least one message and the cell;
creating a tabular diagram using the at least one cell-based statistic for determining a status for the cell;
creating a radio link setup diagram to indicate a number of the radio links associated with the cell that are available as a function of time, a type of the radio link, a relationship the radio link has to a soft handover, and a bandwidth used by the radio link;
creating a bit rate diagram indicating a maximum bit rate and an average bit rate per call as a function of time;
creating a cell-based Signal-to-Interference Ratio (SIR), Quality Estimate (QE), and Cyclic Redundancy Checksum Indicator (CRCI) diagram as a function of time;
creating a dedicated measurement analysis diagram of the calls as a function of time and the cell, said dedicated measurement analysis diagram indicating which calls in the cell influence each other; and
analyzing the tabular diagram, the radio link setup diagram, the bit rate diagram, the cell-based SIR, QE, and CRCI diagram, and the dedicated measurement analysis diagram to determine the usage of the network resources as a function of time.

5. The method of claim 4 further comprising the step of:
determining frequency, scrambling code, defined T-cell value, start time, last event time, Node B name, and status of the cell and providing them to the data record.

6. The method of claim 4 further comprising the step of:
determining a radio link reconfiguration relating to loading of the cell.

7. The method of claim 4 further comprising the step of:
providing parameters to the data record.

8. The method of claim 4 further comprising the step of:
adding an average cell-based value for QE to the dedicated measurement analysis diagram.

9. The method of claim 4 further comprising the step of:
creating a 3-dimensional dedicated measurement diagram indicating dedicated measure reports of the calls as a function of time, the 3-dimensional dedicated measurement diagram capable of indicating influencing between calls.

10. A method for detecting influences between calls in a cell comprising the steps of:
determining cell-based statistics; and
detecting influences between the calls in the cell by creating a radio link setup diagram of the cell-based statistics.

11. A system for providing at least one cell-based statistic for messages related to the same call comprising:
a cell message receiver capable of receiving at least one message into a message coverage area through at least one interface;
a message call linker capable of linking the received said at least one message to other messages in said message coverage area if the received said at least message is part of said call associated with said other messages;
a radio link finder capable of determining a radio link that is associated with the received said at least one message;
a data record creator capable of creating a data record associated with said radio link; and
a data record populator capable of providing said at least one cell-based statistic in said data record, said cell-based statistic associated with the received said at least one message and said message coverage area.

12. The system as in claim 11 wherein said data record populator provides information about said at least one cell-based statistic to said data record.

13. The system as in claim 11 wherein said cell message receiver is capable of incrementing a message count associated with a message coverage area when the received said at least one message is processed.

14. The system as in claim 11 further comprising:
a cell-based statistics processor capable of accessing said data record and providing said at least one cell-based statistic in the form of a diagram.

15. The system as in claim 14 wherein said diagram includes a tabular diagram, a radio link setup diagram, a bit rate diagram, a cell-based Signal-to-Interference Ratio (SIR), Quality estimate (QE), and Cyclic Redundancy Checksum Indicator (CRCI) diagram, and a dedicated measurement analysis diagram.

16. A computer-readable medium having code capable of causing a computer to practice the method of claim 1.

17. A computer signal embodied in electromagnetic signals traveling over a communications network carrying formation capable of causing a computer electronically connected to the communications network to practice the method of claim 1.

18. A system for providing at least one cell-based statistic for at least one message related to the same call, said system comprising:
means for receiving said at least one message into a message coverage area;
means for linking said at least one message with said call with which said at least one message is associated;
means for determining a radio link associated with said at least one message;
means for creating a data record related to said radio link if no said data record has already been established for said radio link; and
means for providing said at least one cell-based statistic to said data record, said at least one cell-based statistic being associated with said at least one message and said message coverage area.

19. The system as in claim 18 further comprising:
means for providing quality information to said data record;
means for providing message coverage area information to said data record;
means for providing measurement results of said at least one cell-based statistic to said data record; and
means for incrementing a message count associated with said message coverage area when said at least one message is processed.

20. The system as in claim 18 wherein said means for receiving comprises:
means for monitoring at least one interface associated with said message coverage area to detect said at least one message;
means for determining from said at least one message said call with which said at least one message is associated; and
means for determining from said call said at least one cell-based statistic.
